(19) United States
(12) Patent Application Publication
(10) Pub. No.: US 2008/0233444 A1
(43) Pub. Date: Sep. 25, 2008

(54) FUEL CELL SYSTEM

(75) Inventors: Ryosuke Yagi, Kawasaki-shi (JP); Yuusuke Sato, Tokyo (JP); Yoshihiro Akasaka, Kawasaki-shi (JP); Masato Akita, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/051,045

(22) Filed: Mar. 19, 2008

(30) Foreign Application Priority Data
Mar. 23, 2007 (JP) P2007-077841

(51) Int. Cl. H01M 8/04

(52) U.S. Cl. 429/22; 429/34

(57) ABSTRACT

A fuel cell system includes: a mixing tank storing a fuel solution; a power generator comprising a membrane electrode assembly having an electrolyte membrane, an anode electrode and a cathode electrode, generating power by reaction of the fuel solution with air; a fuel circulation unit circulating the fuel solution to the anode electrode; an air supply unit supplying air to the cathode electrode; and an air supply mechanism supply air to the anode electrode so as to discharge the fuel solution from the inside of the anode electrode to the mixing tank.

### CROSS REFERENCE TO RELATED APPLICATIONS AND INCORPORATED BY REFERENCE

The application is based upon and claims the benefit of priority from the prior Japanese Patent Applications No. P2007-077841, filed on Mar. 23, 2007; the entire contents of which are incorporated herein by reference.

### BACKGROUND OF THE INVENTION

1. Field of the Invention

This present invention relates to a liquid-type fuel cell system using liquid fuel.

2. Description of the Related Art

In a liquid-type fuel cell that uses a liquid fuel such as methanol, an “active system” is known. In the active system, the fuel and the air, which are required for a reaction in a power generator, are supplied thereto by using auxiliary equipment, such as a pump. By adopting the active system, it is possible to stably obtain a high output even when the environment varies. However, when such an active-system fuel cell is to be used for a mobile system, the active-system fuel cell has problems of being large and complicated since the fuel cell requires a lot of auxiliary equipment. Hence, it is desirable to decrease the auxiliary equipment as much as possible, and to miniaturize the minimum required auxiliary equipment.

For example, in a fuel cell using methanol as the fuel, the methanol and water react with each other in an anode electrode of the power generator. At the same time when such a reaction occurs, “crossover” also occurs. In a crossover process, the methanol and the water, which are supplied to the anode electrode, permeate an electrolyte membrane, and are transferred to a cathode electrode side. The methanol and the water, which crossover, move to the cathode electrode side without contributing to the reaction in the anode electrode. Therefore, as amount of the crossovered methanol and water is large, power generation efficiency of the fuel cell is decreased.

In particular, as the amount of crossover water is large, an amount of the water that moves from the anode side to the cathode side is large. Accordingly, it is necessary to store, in a fuel tank, a large amount of water required in such an anode reaction. In this case, a concentration of the methanol in the fuel tank cannot help but be decreased, and fuel utilization efficiency is decreased. This is disadvantageous to the miniaturization of the volume of the system. When a water collection mechanism is provided to collect the water discharged from the cathode electrode, due to the crossover, and return the collected water to the anode electrode side, the water collector increases the system volume, resulting in a barrier to miniaturization.

In order to decrease the crossover of the water, a membrane electrode assembly (MEA) with low water permeability has been developed. By using the MEA with the low water permeability, a part of the water required in the anode reaction can be supplied from the cathode electrode side in the MEA even if the water collection mechanism is omitted. Accordingly, it is possible to store a higher concentration of methanol into the fuel tank. Moreover, even if the water collection mechanism is provided, a condensation unit for the collection can be miniaturized since the amount of water to be collected by the water collection mechanism is decreased. This contributes to the miniaturization of the system.

However, as the fuel cell system using the MEA having low water permeability is operated for a long period, performance of the MEA is deteriorated, and the amount of crossover water is increased with time from an initial value. If the water collection mechanism is omitted, as crossover of the water is increased, the amount of permeated of water is increased from an initial value as the fuel cell system continues to be operated at a concentration of the methanol initially stored. Accordingly, in some cases, the water required in the anode reaction becomes insufficient, and the fuel cell system is inoperable. On the other hand, if a water collection mechanism is provided, the amount of collected water is increased. As a result, additional loads are applied to the auxiliary equipment for condensation, the amount of power provided to the auxiliary equipment and the like is also increased, and efficiency of the system is decreased.

### SUMMARY OF THE INVENTION

An object of the present invention is to provide a fuel cell system, which can operate while maintaining long term high efficiency in a liquid-type fuel cell.

An aspect of the present invention inheres in a fuel cell system including: a fuel tank configured to store fuel; a mixing tank configured to store a fuel solution diluted from the fuel; a fuel supply unit configured to supply the fuel from the fuel tank to the mixing tank; a power generator including a membrane electrode assembly having an electrolyte membrane, an anode electrode and a cathode electrode, the anode and cathode electrodes sandwich the electrolyte membrane, configured to generate power by reaction of the fuel solution supplied to the anode electrode with air supplied to the cathode electrode; a fuel circulation unit configured to circulate the fuel solution from the mixing tank to the anode electrode; an air supply unit configured to supply air to the cathode electrode; an air supply mechanism configured to supply air to the anode electrode so as to discharge the fuel solution from the inside of the anode electrode to the mixing tank; and a temperature adjustment unit configured to control a temperature of the power generator.

Another aspect of the present invention inheres in a fuel cell system including: a fuel tank configured to store fuel; a mixing tank configured to store a fuel solution diluted from the fuel; a fuel supply unit configured to supply the fuel from the fuel tank to the mixing tank; a power generator including a membrane electrode assembly having an electrolyte membrane, an anode electrode and a cathode electrode, the anode and cathode electrodes sandwich the electrolyte membrane, configured to generate power by reaction of the fuel solution supplied to the anode electrode with air supplied to the cathode electrode; a fuel circulation unit configured to circulate the fuel solution from the mixing tank to the anode electrode; an air supply unit configured to supply air to the anode electrode so as to discharge the fuel solution from the inside of the anode electrode to the mixing tank, and supply air to the cathode electrode; and a temperature adjustment unit configured to control a temperature of the power generator.

Further aspect of the present invention inheres in a fuel cell system including: a fuel tank configured to store fuel; a power generator including a membrane electrode assembly having an electrolyte membrane, an anode electrode and a cathode electrode, the anode and cathode electrodes sandwich the electrolyte membrane, configured to generate power by reaction of the fuel solution supplied to the anode electrode with air supplied to the cathode electrode; a fuel circulation unit configured to circulate the fuel from the fuel tank to the anode electrode; a fuel supply unit configured to supply the fuel from the fuel tank to the fuel circulation unit; a fuel collection unit configured to collect the fuel solution discharged from the anode electrode; and a collection tank configured to collect the fuel solution collected by the fuel collection unit, wherein the fuel collection unit collects the fuel solution discharged from the anode electrode, and air is taken in from the gas discharge port to the anode electrode, and the power generator further comprises an anode passage plate configured to separate the fluid generated by the reaction into liquid and gas.

### BRIEF DESCRIPTION OF DRAWINGS

FIG. 1 is a block diagram showing an example of a fuel cell system according to a first embodiment of the present invention.

FIG. 2 is a cross-sectional view showing an example of a fuel cell according to the first embodiment of the present invention.

FIG. 3 is a flowchart for explaining an example of an operating method of the fuel cell system according to the first embodiment of the present invention.

FIGS. 4 and 5 are graphs for explaining about α recovery processing of the fuel cell system according to the first embodiment of the present invention.

FIG. 6 is a block diagram showing an example of a fuel cell system according to the first modification of the first embodiment of the present invention.

FIG. 7 is a flowchart for explaining an example of an operating method of the fuel cell system according to the second modification of the first embodiment of the present invention.

FIG. 8 is a block diagram showing an example of a fuel cell system according to the third modification of the first embodiment of the present invention.

FIGS. 9 and 10 are graphs for explaining a timing of α recovery processing in the fuel cell system according to the fourth modification of the first embodiment of the present invention.

FIG. 11 is a block diagram showing an example of a fuel cell system according to a second embodiment of the present invention.

FIG. 12 is a cross-sectional view showing an example of a fuel cell according to the second embodiment of the present invention.

FIG. 13 is a flowchart for explaining an example of an operating method of the fuel cell system according to the second embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Generally and as it is conventional in the representation of devices, it will be appreciated that the various drawings are not drawn to scale from one figure to another nor inside a given figure, and in particular that the layer thicknesses are arbitrarily drawn for facilitating the reading of the drawings.

In the following descriptions, numerous specific details are set fourth to provide a thorough understanding of the present invention. However, it will be obvious to those skilled in the art that the present invention may be practiced without such specific details.

### First Embodiment

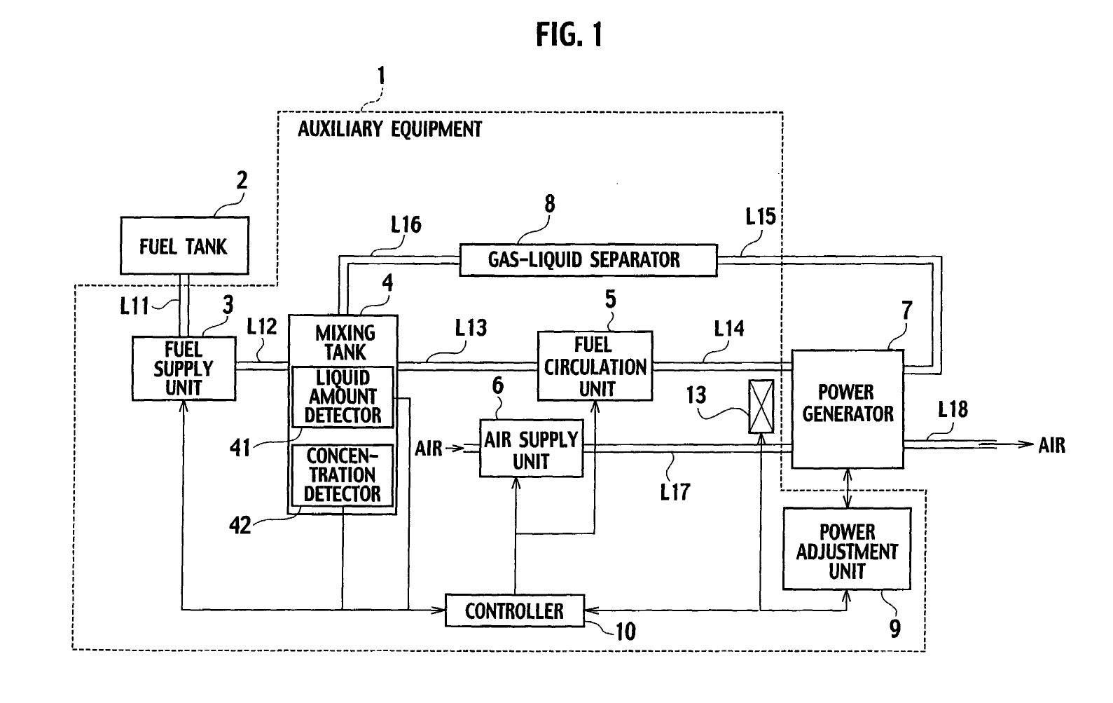

A system using a direct methanol fuel cell (DMFC) will be described as the fuel cell system according to a first embodiment of the present invention. As shown in FIG. 1, the fuel cell system according to the first embodiment of the present invention includes a power generator 7, a fuel tank 2, and an auxiliary equipment 1 required for the power generator 7.

The auxiliary equipment 1 includes a fuel supply unit 3, a mixing tank 4, a fuel circulation unit 5, an air supply mechanism (gas-liquid separator) 8, an air supply unit 6, a power adjustment unit 9, a temperature adjustment unit 13, a liquid level (amount) detector 41, a concentration detector 42, and a controller 10.

The fuel tank 2 and the fuel supply unit 3 are connected to each other through a line L11. The fuel supply unit 3 and the mixing tank 4 are connected to each other through a line L12. The mixing tank 4 and the fuel circulation unit 5 are connected to each other through a line L13. Anode electrodes of the power generator 7 and the fuel circulation unit 5 are connected to each other through a line L14. The anode electrodes of the power generator 7 and the gas-liquid separator 8 are connected to each other through a line L15. The mixing tank 4 and the gas-liquid separator 8 are connected to each other through a line L16. Cathode electrodes of the power generator 7 and the air supply unit 6 are connected to each other through a line L17. A line L18 is connected to the cathode electrodes of the power generator 7.

The fuel tank 2 stores the fuel or a high concentration fuel solution containing the fuel and a small amount of water. The fuel supply unit 3 supplies the methanol or high concentration methanol solution, which is supplied from the fuel tank 2, to the mixing tank 4 through the line L12. The mixing tank 4 mixes the methanol or the high concentration methanol solution, which is supplied from the fuel supply unit 3 through the line L12 with fluid that contains a methanol solution. The fluid is discharged from the power generator 7 through the line L15. Then, the mixing tank 4 stores a methanol solution with a concentration optimum for the power generation.

The fuel circulation unit 5 supplies the methanol solution in the mixing tank 4 through the line L14 to the anode electrodes of the power generator 7, and circulates the fluid, which contains the methanol solution and is discharged from the power generator 7, to the mixing tank 4 through the lines L15 and L16. Since gas such as carbon dioxide (CO₂) is also contained in the fluid discharged from the power generator 7, the gas-liquid separator 8 separates the fluid into gas and liquid, and discharges the gas to the atmosphere. It is also possible to place the gas-liquid separator 8 in the mixing tank 4 and to omit the line L16. The air supply unit 6 supplies air, which is taken in from the outside, through the line L17 to the cathode electrodes of the power generator 7. Pumps, such as electromagnetic pumps and air pumps, are usable for the fuel supply unit 3, the fuel circulation unit 5, and the air supply unit 6. When the methanol solution is sent under pressure from the fuel tank 2, such as in the case of sealing liquefied gas in the fuel tank 2 and sending the methanol solution by using a vapor pressure of the liquefied gas, a flow rate adjustment valve or an on/off valve is usable for the fuel supply unit 3.

The power adjustment unit 9 removes electrical energy from the power generator 7. The temperature adjustment unit 13 adjusts the temperature of the power generator 7. A heater, a fan, a Peltier device, a water-cooling jacket, or the like may be used as the temperature adjustment unit 13. The liquid level detector 41 is provided in the mixing tank 4. The liquid level detector 41 detects an amount of liquid in the mixing tank 4. The concentration detector 42 detects the concentration of the methanol. The concentration detector 42 may be provided in the mixing tank 4, on the line L13 between the fuel circulation unit 5 and the mixing tank 4, or on the line L14 between the fuel circulation unit 5 and the power generator 7. Here, with regard to a detecting method of such a methanol concentration, it is also possible to determine the methanol concentration based on a relationship between the output or temperature of the power generator 7 and the number of revolutions of the temperature adjustment unit 13 instead of using the concentration detector 42.

The controller 10 is, for example, a central processing unit (CPU). An input/output device and a storage device, which are not shown, are connected to the controller 10. The controller 10 is connected to the fuel supply unit 3, the liquid level detector 41, the concentration detector 42, the air supply unit 6, the fuel circulation unit 5, the temperature adjustment unit 13, and the power adjustment unit 9. The controller 10 obtains information regarding the amount of liquid and concentration of the fuel solution in the mixing tank 4 from the liquid level detector 41 and the concentration detector 42. Then, the controller 10 provides control signals for controlling the fuel supply unit 3, the air supply unit 6, the fuel circulation unit 5, the temperature adjustment unit 13, and the power adjustment unit 9 individually so that the fuel solution in the mixing tank 4 can remain within the optimum concentration range and that the amount of liquid of the fuel solution can remain within a predetermined range.

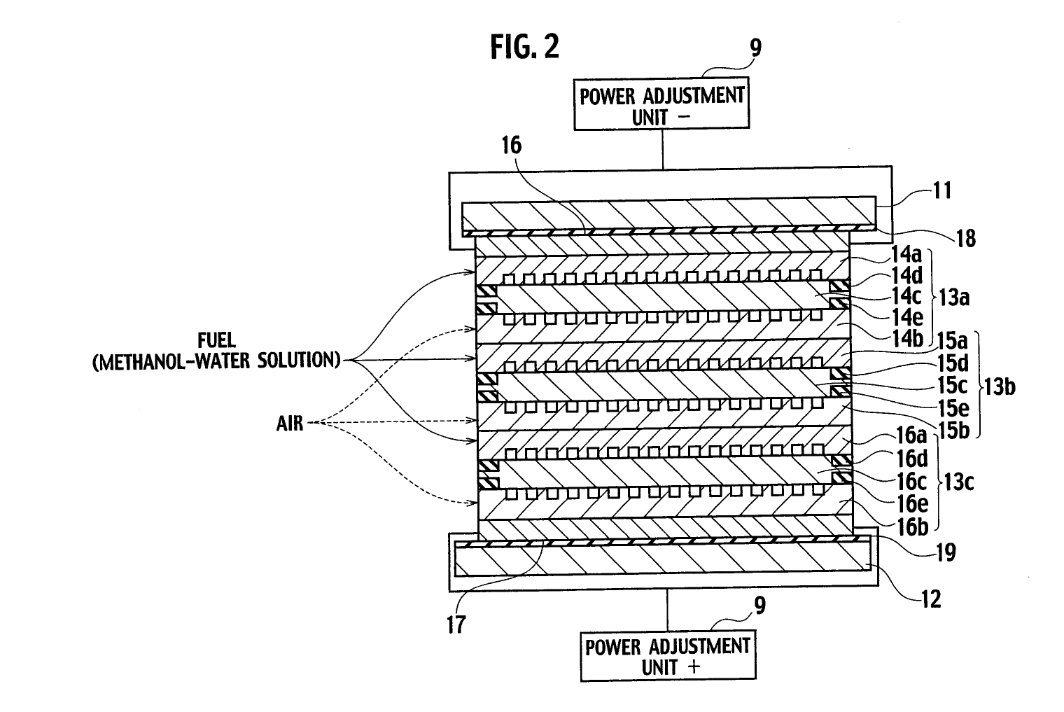

As shown in FIG. 2, in the power generator 7, a plurality of power generation cells 13a, 13b and 13c, each of which is considered as a unit, are stacked in series. The power generation cell 13a includes a membrane electrode assembly (MEA) 14c with low water permeability, an anode passage plate 14a facing to an anode electrode side of the MEA 14c, and a cathode passage plate 14b facing to a cathode electrode side of the MEA 14c. The power generation cell 13b includes an MEA 15c, an anode passage plate 15a facing to an anode electrode side of the MEA 15c, and a cathode passage plate 15b facing to a cathode electrode side of the MEA 15c. The power generation cell 13c includes an MEA 16c, an anode passage plate 16a facing to an anode electrode side of the MEA 16c, and a cathode passage plate 16b facing to a cathode electrode side of the MEA 16c.

Each of the MEAs 14c, 15c and 16c includes: an electrolyte membrane formed of a proton-conductive polymer electrolyte membrane; anode and cathode electrodes formed by coating catalysts on both surfaces of the electrolyte membrane; and a carbon micro porous layer (MPL), an anode gas diffusion layer (GDL), and a cathode gas diffusion layer, which are provided on the outsides of the anode and cathode electrodes. For example, a Nafion membrane (registered trademark) may be used as the electrolyte membrane, platinum ruthenium (PtRu) may be used as the catalyst of the anode electrode, and platinum (Pt) may be used as the catalyst of the cathode electrode.

The carbon micro porous layer, the anode gas diffusion layer and the cathode gas diffusion layer supply the fuel and the air to the power generator, discharge a reaction product therefrom, and smoothly collect electrons obtained by a reaction therein. The carbon micro porous layer is fabricated by the steps of spray coating a mixture of carbon fine powder and polytetrafluoroethylene (PTFE) resin on carbon paper, and heating the mixture and the carbon paper. In the carbon micro porous layer fabricated by the above-described steps, both porosity and a pore diameter are smaller than in the carbon paper, and liquid permeability is lower than in the carbon paper. The carbon micro porous layer formed by the water repellent treatment of commercially available carbon paper by PTFE is usable as the anode gas diffusion layer, and commercially available carbon cloth attached to the carbon micro porous layer is usable as the cathode gas diffusion layer.

Conductive carbon is usable as a material for the anode passage plates 14a, 15a and 16a and the cathode passage plates 14b, 15b and 16b. The anode passage plates 14a, 15a and 16a supply the methanol solution, which is supplied from the fuel circulation unit 5, to the anode electrodes of the MEAs 14c, 15c and 16c, respectively, and discharge the fluid generated by the reaction. The cathode passage plates 14b, 15b and 16b supply the air, which is supplied from the air supply unit 6, to the cathode electrodes of the MEAs 14c, 15c and 16c, and discharge the permeated water generated by the reaction.

An insulating sheet 18 is disposed between an anode collector 16 and a clamping plate 11. The anode collector 16 is disposed on an outside of the anode passage plate 14a, and is connected to the power adjustment unit 9. The clamping plate 11 is placed on an outside of the anode collector 16. An insulating sheet 19 is disposed between a cathode collector 17 and a clamping plate 12. The cathode collector 17 is placed on an outside of the cathode passage plate 16b, and is connected to the power adjustment unit 9. The clamping plate 12 is placed on an outside of the cathode collector 17.

The anode collector 16 and the cathode collector 17 collect electricity generated by the power generation cells 13a, 13b and 13c. The clamping plates 11 and 12 sandwich and fix the power generation cells 13a, 13b and 13c, the anode collector 16 and the cathode collector 17 therebetween.

O-rings, rubber sheets or the like are usable as gaskets 14d, 14e, 15d, 15e, 16d and 16e. The gaskets 14d, 14e, 15d, 15e, 16d and 16e insulate the anode passage plates 14a, 15a and 16a and the cathode passage plates 14b, 15b and 16b, respectively, and prevent leakage of the fuel and the air.

Next, a description will be made of the procedure of a normal operation of the fuel cell system according to the first embodiment of the present invention. First, the fuel circulation unit 5 shown in FIG. 1 supplies the methanol solution individually to the anode passage plates 14a, 15a and 16a of the power generator 7. Moreover, the air supply unit 6 supplies the air to the cathode passage plates 14b, 15b and 16b of the power generator 7. The reactions in the anode electrode and the cathode electrode in each of the MEAs 14c, 15c and 16c of the power generator 7 are represented as:

anode electrode: CH₃OH+H₂O→6H⁺+6e⁻+CO₂ (1)

cathode electrode: 6H⁺+6e⁻+3/2O₂→3H₂O (2)

In each anode electrode, the methanol and the water react with each other in a molar ratio of 1:1. A product, such as carbon dioxide (CO₂), generated in the anode electrode and the methanol solution that is unreacted are discharged from the line L15 shown in FIG. 1, and the gas, such as carbon dioxide (CO₂), is removed therefrom in the gas-liquid separator 8. Thereafter, the unreacted methanol solution is returned to the mixing tank 14 through the line L16. The water generated in each cathode electrode of the power generator 7 is discharged from the line L18. Note that the line L18 may be connected to the mixing tank 4, and the water generated in the cathode electrode of the power generator 7 may be returned to the mixing tank 4.

At this time, a crossover occurs in which the methanol and the water which are supplied to the anode electrode permeate the electrolyte membrane and transfer to the cathode electrode side. The temperature of the power generator 7 rises by heat generated due to the crossover of the methanol. When the temperature reaches a predetermined temperature or more, the power adjustment unit 9 performs a process for removing the electrical energy from the power generator 7, and the fuel cell system starts to generate power. During the power generation, the temperature adjustment unit 13 adjusts the temperature of the power generator 7. Since the methanol and the water in the mixing tank 4 are decreased due to the crossover, the fuel supply unit 3 supplies the methanol or the methanol solution to the mixing tank 4. The concentration of the fuel in the fuel tank 2 is determined by the amount of water and methanol crossover, and is determined by initially measuring characteristics of the MEAs 14c, 15c and 16c.

Here, the crossover amount a in each of the MEAs 14c, 15c and 16c of the power generator 7 is defined by the following expression where t is the amount of H₂O permeation (mol/s), and m is the amount of H⁺ movement (mol/s):

α=t/m (3)

For example, when α is equal to 0, 1 mol of the methanol and 1 mol of the water react with each other, and 6 moles of H⁺ move from the anode electrode through the electrolyte membrane to the cathode electrode; however, the water does not move following the movement of the protons. This means that there is no crossover of the water, and in the case of constructing a system that omits a mechanism for collecting the water in the cathode under such a condition without any water crossover, the methanol and the water which are required for the anode reaction just need to be stored into the fuel tank 2 in a ratio of 1 mol:1 mol. Moreover, when α is equal to −1/6, 1 mol of the methanol and 1 mol of the water react with each other, and six mol of H⁺ are generated. At the same time, 1 mol of the water moves (is reversely diffused) from the cathode electrode through the electrolyte membrane to the anode electrode. The water required in the anode reaction can be supplemented with the water reversely diffused as described above. Accordingly, it is not necessary to store the water into the fuel tank 2, and it is possible to store the methanol with a concentration of 100%.

When the system is operated for a long period, a phenomenon is observed, that performance of the MEAs 14c, 15c and 16c is deteriorated, and the amount of crossover of the water is increased with time from an initial value thereof. When the amount of crossover water increases with time from the initial value as a result of the deterioration, the amount of water in mixing tank is reduced. The concentration of the methanol in the fuel tank 2 is determined based on the initial ratio of the amount of crossover of the water and the methanol. Accordingly, when the concentration of the fuel remains constantly in a state where the amount of crossover water is increased, the amount of liquid is decreased due to a shortage of the water. When the system continues to be operated while being left in such a state, there is a case where the system will finally become inoperable because of a shortage of water, or the like, which may be caused by an extreme decrease of the amount of liquid.

From the foregoing, the following can be understood. Specifically, this increase of the amount of crossover water, which increases with time, is caused by the fact that the water is accumulated insides of the anode gas diffusion layer (GDL) and the carbon micro porous layer (MPL) which initially have strong water repellency, resulting in a decrease of the water repellency. When the anode electrode is dried to recover the water repellency, each MEA can recover from the increase in the amount of crossover water.

Accordingly, in order to reduce the amount of crossover water from the increased amount to a lower amount, a “α recovery processing” for supplying air to each anode electrode of the power generator 7, and discharging the methanol solution accumulated in the anode electrode of the power generator 7 is performed, thereby drying the inside of the anode electrode of the power generator 7.

In the α recovery processing, first, the supply of fuel, the circulation of fuel, the supply of air, and the extraction of electrical energy, which are performed by the fuel supply unit 3, the fuel circulation unit 5, the air supply unit 6, and the power adjustment unit 9, are discontinued, and the power generation operation is ended. Next, the fuel circulation unit 5 reversely circulates the fuel so that the fuel can flow from the gas-liquid separator 8 to the power generator 7. When an inner pressure of the gas-liquid separator 8 becomes lower than the atmospheric pressure at the time of this operation, the air flows into the line L15 through a gas/liquid separation membrane, and the methanol solution in the anode electrode of the power generator 7 is discharged to the mixing tank 4 through the line L14. When this operation is further continued, the air taken in from the gas-liquid separator 8 is discharged through the power generator 7 from a vent hole or the like in the mixing tank 4, and the water is removed from the inside of the anode electrode of the power generator 7. As a result, the inside of the anode electrode of the power generator 7 can be dried. In order to determine whether or not to end the α recovery process, a hygrometer for measuring air humidity in the power generator 7 is provided inside or outside of the power generator 7. Then, when the measured humidity reaches a predetermined value or less, the α recovery process is ended. Alternatively, the α recovery process may be automatically ended after lapse of a fixed time when the measured humidity reaches the predetermined value or less.

Note that, in addition to that the liquid being discharged as described above by reversely rotating the fuel circulation unit 5, the liquid may be discharged by using a liquid discharge pump provided exclusively for discharging the liquid from the inside of the anode electrode of the power generator 7.

Moreover, in the α recovery process, the higher the temperature of the power generator 7, the more the capability of discharging the liquid in the anode electrode can be enhanced. Hence, a process may be adopted, such as preventing a drop of the temperature of the power generator 7 by controlling the temperature adjustment unit 13 to suppress such a drop, and raising the temperature of the power generator 7 at the time of the α recovery process by disposing a heater in the power generator 7.

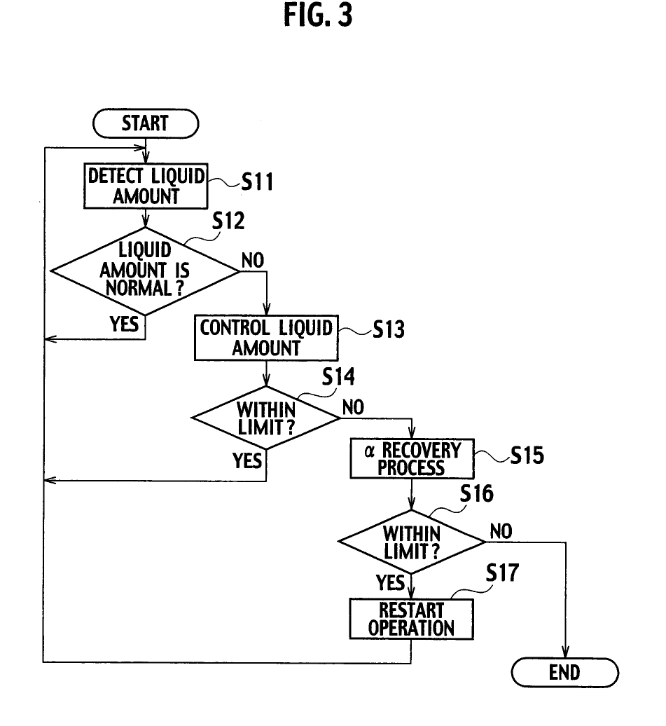

Next, an operation method of the fuel cell system including the α recovery process according to the first embodiment of the present invention will be described, referring to the flowchart of FIG. 3.

In Step S11, the operation is started. During the operation, the liquid amount detector 41 detects the amount of the liquid methanol solution in the mixing tank 4. In Step S12, the controller 10 determines whether or not the amount of liquid detected by the liquid amount detector 41 is within a predetermined range. The operation is normal when the amount of liquid is within the predetermined range, and accordingly, the operation is continued while periodically detecting the amount of liquid. When the amount of liquid is not within such a normal range, the method proceeds to Step S13.

In Step S13, liquid amount control processing is performed. In the liquid amount control processing, for example, the fuel supply unit 3 adjusts a supply of the fuel, and the power adjustment unit 9 adjusts a load, so that the amount of liquid can return to the predetermined range. The liquid amount control processing is repeatedly performed within a time limit or a number limit until the amount of liquid returns to the predetermined range. In Step S14, the controller 10 determines whether or not the amount of liquid has returned to the predetermined range. When the amount of liquid has returned to the predetermined range, the method returns to Step S11. On the other hand, when it has been impossible to restore the liquid to such a normal range within the time limit or the number limit, the method proceeds to Step S15.

In Step S15, the power generation operation is discontinued, and the α recovery processing is performed. In the α recovery processing, air is supplied to each anode electrode of the power generator 7, and the methanol solution accumulated in the anode electrode is discharged, whereby the inside of the anode electrode is dried. In such a way, each MEA can be recovered from an increased amount of the crossover water.

In Step S16, the operation is resumed, and the controller 10 determines whether or not the amount of liquid has returned to the normal range based on a detecting result by the liquid amount detector 41. Here, when the controller 10 determines that the amount of liquid has returned to the normal range, the method proceeds to Step S17, and the operation is continued. When the amount of liquid has not been restored to the predetermined range, other factors may be preventing the amount of liquid from within the predetermined range, and accordingly, the operation is discontinued.

In accordance with the fuel cell system according to the first embodiment of the present invention, when the MEAs 14c, 15c and 16c are deteriorated over time and the amount of crossover water is increased from the initial value, air is supplied to the anode electrodes of the power generator 7, and the fuel solution accumulated in the anode electrodes of the power generator 7 is returned to the mixing tank 4, whereby the anode passage plates 14a, 15a and 16a and the insides of the anode electrodes of the MEAs 14c, 15c and 16c can be dried. In such a way, the water repellency of the anode electrodes can be restored, and the low water permeability intrinsic to the membrane electrode assemblies can be restored. Hence, it is possible to maintain high power generation efficiency and fuel utilization efficiency for a long period of time.

Moreover, since the mixing tank 4 for supplying the fuel is provided, at the time of the α recovery processing, it is possible to return, to the mixing tank 4, the fuel solution and the like, which are discharged from the anode electrodes of the power generator 7.

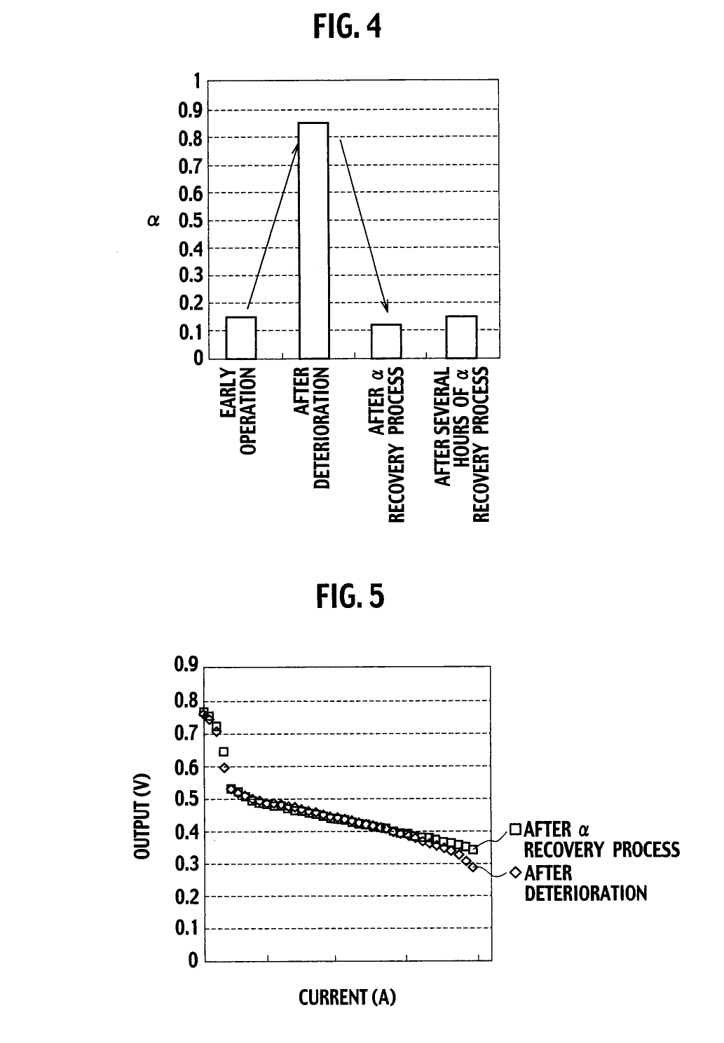

FIG. 4 shows a result of the recovery of the crossover water when the air is supplied to the anode electrodes of the power generator 7 shown in FIG. 1, the liquid accumulated in the anode electrodes is discharged, and the anode electrodes are dried. In FIG. 4, while the initial amount of crossover water was 0.15, the amount of crossover water after the fuel cell system was operated for a long period was increased to approximately 0.85. Accordingly, the process for discharging the methanol solution in the anode electrodes, supplying the air to the anode electrodes, and drying the anode electrodes for 10 minutes was performed. As a result, the amount of crossover water was recovered to 0.15 that was the initial value. It can be understood that thereafter, the amount of crossover water was not radically increased, but was restored within a range of the initial value, and it was possible to obtain stable performance of the power generator 7.

Furthermore, FIG. 5 shows a graph that compares outputs of the fuel cell system before and after performing the α recovery process. In FIG. 5, it can be seen that the output after the α recovery process did not deteriorate in comparison with the output before the α recovery process (and after the MEAs are deteriorated). Accordingly, it can be understood that the α recovery process is capable of recovering the crossover water without damaging the output performance of the power generator 7.

### (First Modification)

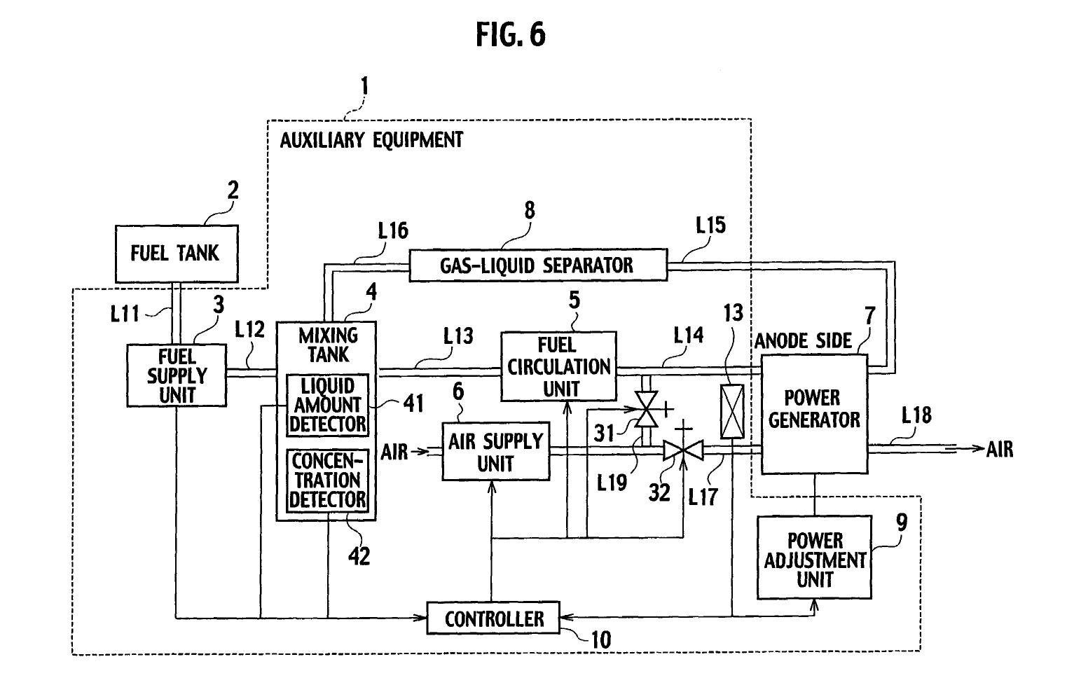

A case will be described where, in the α recovery processing, the air supply unit 6 dries the anode electrodes of the power generator 7 by supplying air thereto as a first modification of the first embodiment of the present invention. In a fuel cell system according to the first modification of the first embodiment of the present invention, as shown in FIG. 6, there is provided a line L19 that connects the line L17 and the line L14 to each other in order to make it possible to supply the air to the anode electrodes of the power generator 7. In the line L19, a first valve (opening/closing mechanism) 31 is provided. Moreover, in the line L17 between the air supply unit 6 and the anode electrode of the power generator 7, a second valve (opening/closing mechanism) 32 is provided. The first and second valves 31 and 32 are controlled by the controller 10.

The first and second valves 31 and 32 switch the flow of the air between the time of the normal operation and the time of the α recovery process. Specifically, at the time of normal operation, the first valve 31 is closed, whereby the air supplied from the air supply unit 6 is inhibited from flowing into the anode electrodes of the power generator 7, and the second valve 32 is opened, whereby the air flows into the cathode electrodes of the power generator 7. At the time of the α recovery process, the second valve 32 is closed, whereby the air is inhibited from flowing into the cathode electrodes of the power generator 7, and the first valve 31 is opened, whereby the air flows into the anode electrodes of the power generator 7.

In accordance with the first modification of the first embodiment of the present invention, the first and second valves 31 and 32 are controlled to supply the air from the air supply unit 6 to the anode electrodes of the power generator 7, whereby the α recovery process can be performed.

### (Second Modification)

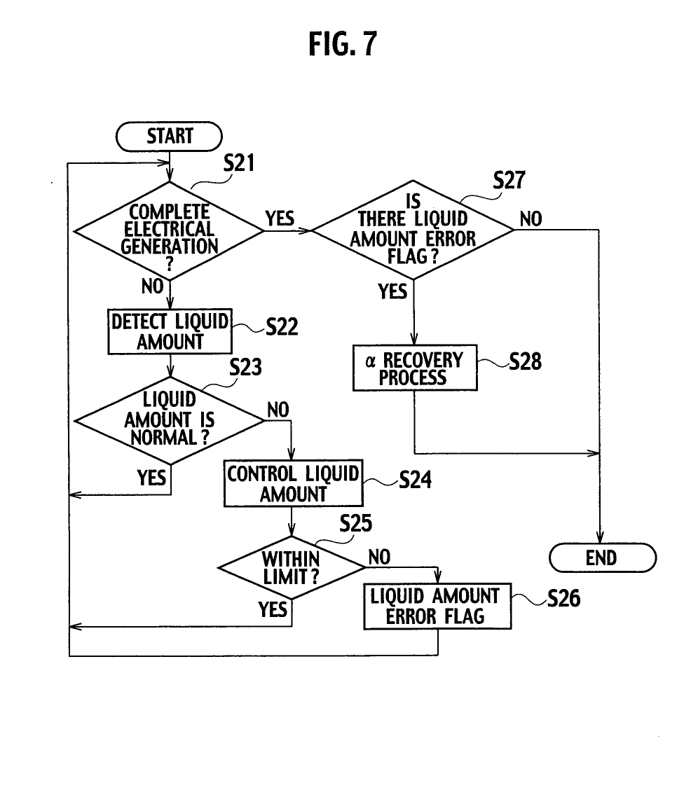

An operation method of the fuel cell system, in which the α recovery process is performed after the power generation has ended, will be described as a second modification of the first embodiment of the present invention while referring to the flowchart of FIG. 7.

In Step S21, the operation is maintained until the power generation is required to be terminated. In Step S22, the liquid amount detector 41 detects the amount of liquid in the mixing tank 4 during power generation. Based on a result of the liquid amount detector 41, the controller 10 determines whether or not the amount of liquid is within the predetermined range. When the amount of liquid is within the predetermined range, operation of the power generator is maintained, and thereafter, the liquid amount detector 41 periodically detects the amount of liquid. When the amount of liquid is not within the predetermined range, the method proceeds to Step S24.

In Step S24, the liquid amount control processing is performed. In Step S25, the controller 10 determines whether or not the amount of liquid has been restored to the normal range within the time limit or the number limit. When the proper amount of liquid has been restored in the normal range, the method returns to Step S21. When the proper amount of liquid has not been restored to the normal range within the time limit or the number limit, a flag indicating that the liquid amount is abnormal is raised in Step S26, and the method returns to Step S21. The flag is stored, for example, in a storage device (not shown) connected to the controller 10.

When the power generation is required to end in Step S21, the method proceeds to Step S27. In Step S27, the controller 10 determines whether or not the flag is present. When the flag is not present, the operation is completed without doing anything. When the flag is present, the method proceeds to Step S28.

In Step S28, the power generation ends, and the α recovery process is performed. In this case, it is desirable that the controller 10 issues a notice that the system will enter a maintenance mode after the end of the power generation. The notice is issued to a user through an output device and the like so as to obtain permissions to operate the fuel circulation unit 5 and the air supply unit 6 after ending the power generation, to use an external power supply and the like for this purpose. After the α recovery process has been completed, the operation is completed. When the system is activated next time, the amount of liquid is once more determined.

In accordance with the second modification of the first embodiment of the present invention, the α recovery process is not performed while the system is generating power, but is performed after the end of the power generation, whereby the system will becomes usable without being forced to discontinue the supply of power when the power is being used.

### (Third Modification)

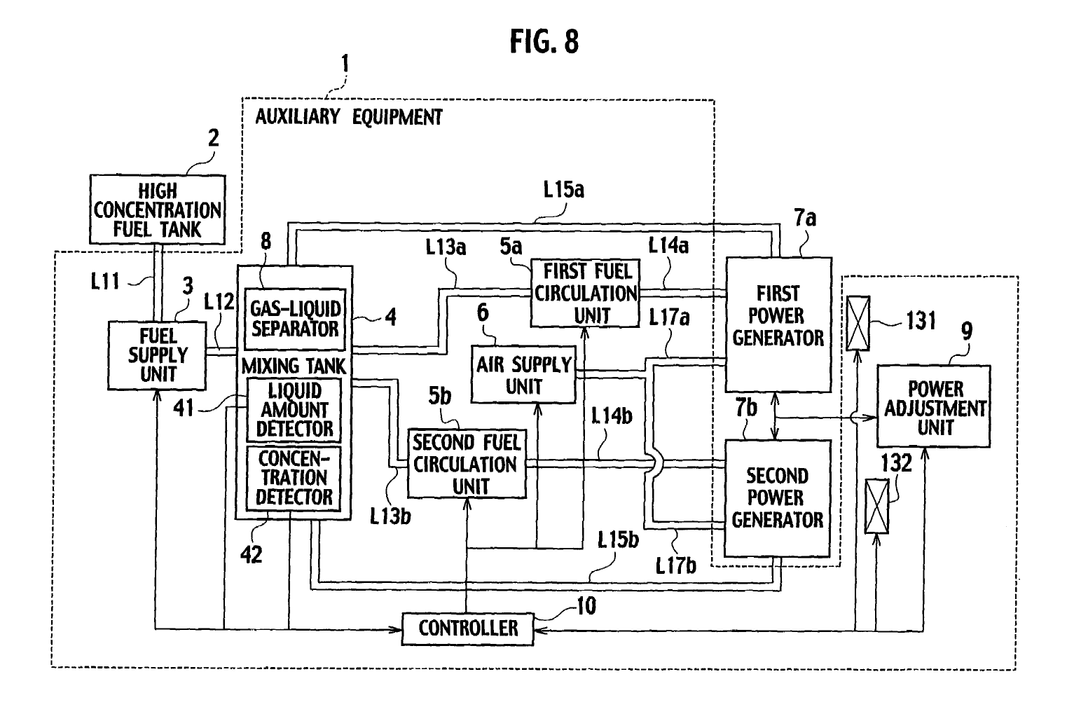

The case where the α recovery process is performed for a plurality of power generators will be described as a third modification of the first embodiment of the present invention. As shown in FIG. 8, a fuel cell system according to the third modification of the first embodiment of the present invention includes a plurality (first and second) of power generators 7a and 7b, the fuel tank 2, and the auxiliary equipment 1. The auxiliary equipment 1 includes the fuel supply unit 3, the mixing tank 4, first and second fuel circulation units 5a and 5b, the gas-liquid separator 8, the air supply unit 6, the power adjustment unit 9, first and second temperature adjustment units 131 and 132, the liquid amount detector 41, the concentration detector 42, and the controller 10.

The fuel tank 2 and the fuel supply unit 3 are connected to each other through the line L11. The fuel supply unit 3 and the mixing tank 4 are connected to each other through the line L12. The mixing tank 4 and the first fuel circulation unit 5a are connected to each other through a line L13a. The mixing tank 4 and the second fuel circulation unit 5b are connected to each other through a line L13b. The first and second power generators 7a and 7b and the air supply unit 6 are connected to each other through lines L14a and L14b, respectively. The first and second power generators 7a and 7b and the mixing tank 4 are connected to each other through lines L15a and L15b, respectively.

The gas-liquid separator 8 is attached to a part of the mixing tank 4. The gas-liquid separator 8 separates a fluid discharged from the first and second power generators 7a and 7b into gas and liquid, discharges the gas to the atmosphere, and returns the liquid to the mixing tank 4.

The first and second fuel circulation units 5a and 5b supply the methanol solution in the mixing tank 4 through the lines L14a and L14b to anode electrodes of the first and second power generators 7a and 7b, respectively, and return the solution, which is unused in the first and second power generators 7a and 7b, to the mixing tank 4 through the lines L15a and L15b. The air supply unit 6 supplies the air to cathode electrodes of the first and second power generators 7a and 7b through lines L17a and L17b.

The power adjustment unit 9 is connected to the first and second power generators 7a and 7b. The power adjustment unit 9 removes the electrical energy from the first and second power generators 7a and 7b. The first and second temperature adjustment units 131 and 132 are arranged in the vicinities of the first and second power generators 7a and 7b, respectively. The first and second temperature adjustment units 131 and 132 adjust temperatures of the first and second power generators 7a and 7b. Other configurations are substantially similar to the configurations of the fuel cell system shown in FIG. 1, and accordingly, a duplicate description will be omitted.

Next, a description will be made of an operation method of the fuel cell system according to the third modification of the first embodiment of the present invention.

In the fuel cell system shown in FIG. 8, both of the first and second power generators 7a and 7b perform the usual power generation operations. When the amount of liquid in the mixing tank 4 fails to stay within a predetermined range during power generation, and cannot return to the predetermined range even when the liquid amount control processing is performed, only one of either the first and second power generators 7a and 7b is stopped. For example, while the first power generator 7a is continuing to generate power, the fuel circulation and load of the second power generator 7b is stopped, and the α recovery process is performed for the second power generator 7b. Power required during the α recovery processing is supplied to the second power generator 7b by the power generation of the first power generator 7a.

Then, after the α recovery process for the second power generator 7b is ended, the fuel supply unit 3 supplies the fuel to the second power generator 7b, and the second power generator 7b resumes power generation. Thereafter, the first power generator 7a is stopped, and the α recovery process operation is shifted to α recovery processing for the first generation unit 7a. After the α recovery process for the first power generator 7a has ended, the first power generator 7a also resumes power generation.

In accordance with the fuel cell system according to the third modification of the first embodiment of the present invention, the α recovery process is performed alternately for the first and second power generators 7a and 7b, whereby, even if the first power generator 7a as one of the plurality of power generating units is undergoing the α recovery process, the power generator 7b as the other of the plurality of power generating units can generate and supply power to the first power generator 7a. Accordingly, the α recovery process can be performed without supplying power from the external power supply to the first power generator 7a, and it is possible to perform the α recovery process without discontinuing power generation.

Note that, although two (first and second) power generators 7a and 7b are shown in FIG. 8, three or more power generators may be provides, and the α recovery processing may be performed individually.

As an example that the power generators perform α recovery processing individually while continuing power generation by the power generators, α recovery processing may be performed for each of the power generators sequentially.

### (Fourth Modification)

A case where the α recovery process is periodically performed, in advance of need, will be described as a fourth modification of the first embodiment of the present invention.

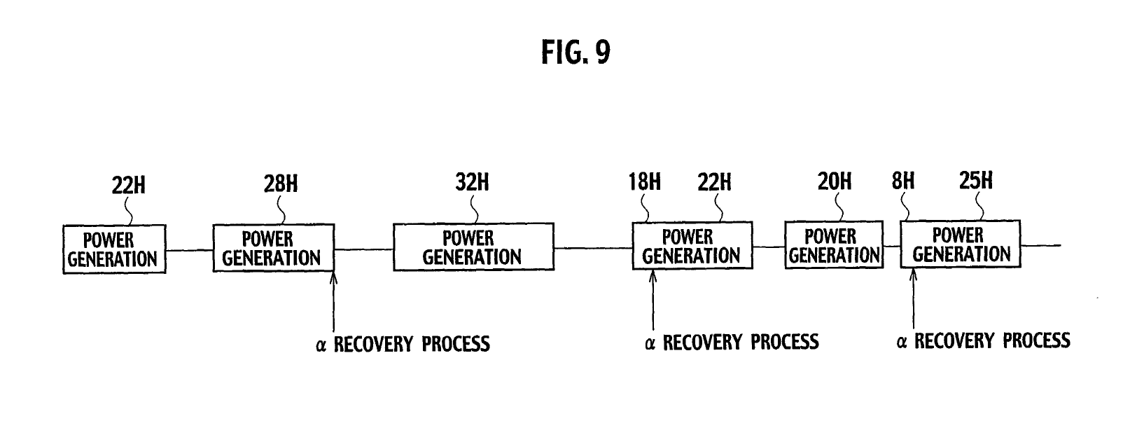

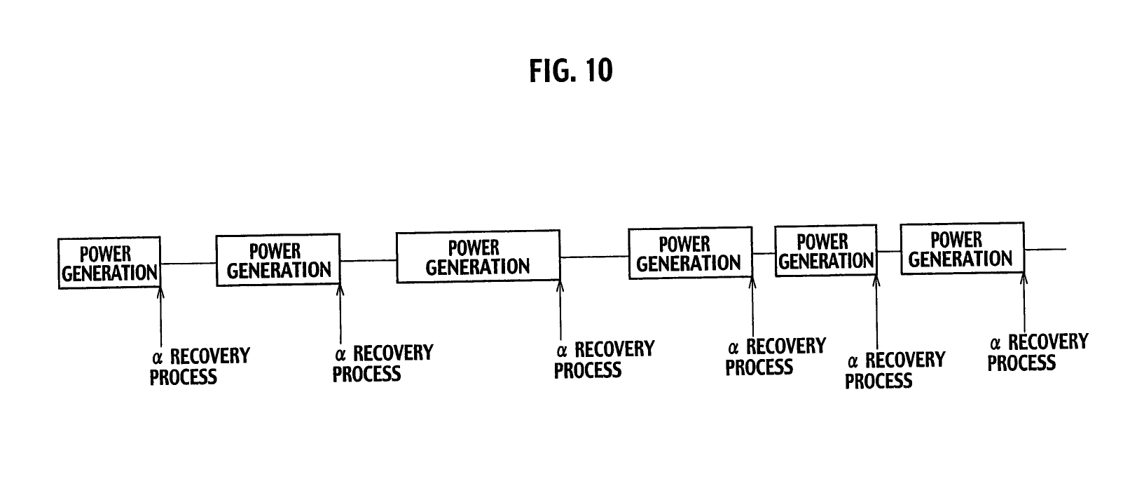

In the fuel cell system shown in FIG. 1, for example, as shown in FIG. 9, a α recovery process mode may be adopted that is incorporated in the process for each operation for a fixed time (here, for example, 50 hours). As shown in FIG. 10, a recovery mode may be adopted, in which, at every time of ending the power generating operation, the system is stopped after incorporating the α recovery processing.

As opposed to the method of the α recovery process when the amount of liquid and the concentration are out of the predetermined ranges and recovering the crossover water from the increased state, in accordance with the fourth modification of the first embodiment of the present invention, the increase of the crossover water can be prevented before it occurs in a method that incorporates the α recovery process for a period or for an operation. Accordingly, the deterioration of the MEAs 14c, 15c and 16c can be suppressed, and a time for the α recovery process can be shortened.

### Second Embodiment

A fuel cell system without the mixing tank 4 and the gas-liquid separator 8 shown in FIG. 1 will be described, as a second embodiment of the present invention. The fuel cell system includes an anode circulation system for a power generator. The anode circulation system circulates a constant amount of liquid.

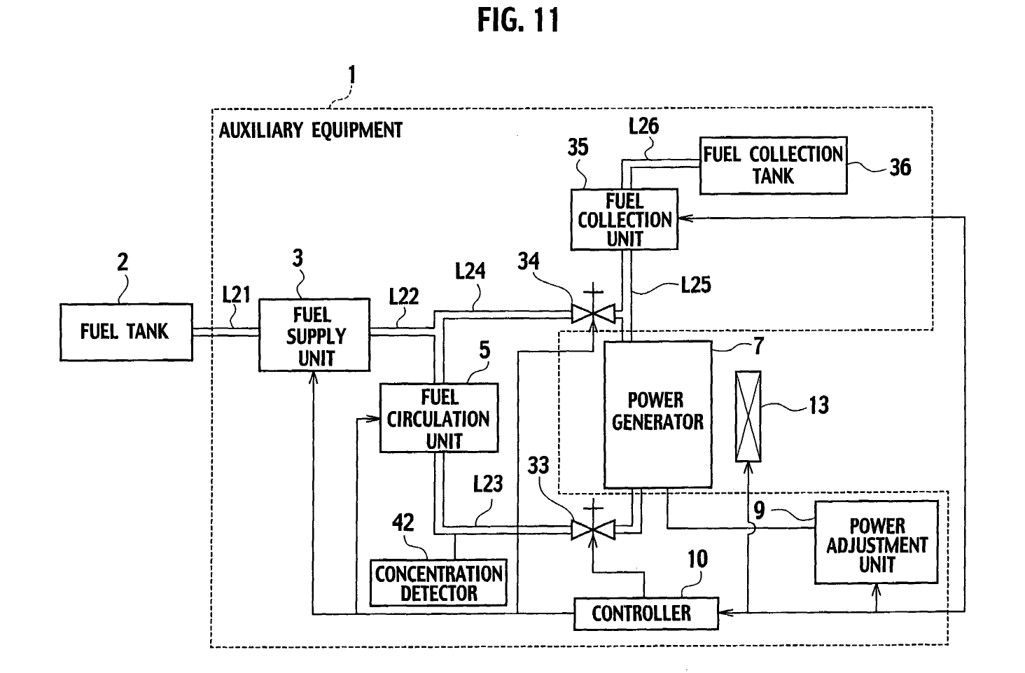

As shown in FIG. 11, the fuel cell system according to the second embodiment of the present invention includes a power generator 7, a fuel tank 2 and an auxiliary equipment 1. The fuel tank 2 stores methanol or a mixed solution containing methanol and a small amount of water. The concentration of the methanol stored in the fuel tank 2 is determined by considering the amount of crossover of water and methanol.

The auxiliary equipment 1 includes a fuel supply unit 3, a fuel circulation unit 5, a fuel collection unit 35, a fuel collection tank 36, a first valve 33, a second valve 34, a power adjustment unit 9 and a temperature adjustment unit 13.

The fuel tank 2 and the fuel supply unit 3 are connected to each other through a line L21. The power generator 7 and the fuel circulation unit 5 are connected to each other through lines L23 and L24. The power generator 7 and the fuel collection unit 35 are connected to each other through a line L25. The fuel collection unit 35 and the fuel collection tank 36 are connected to each other through a line L26. A loop is formed by the power generator 7, the fuel circulation unit 5 and the lines L23 and L24. The loop circulates the methanol solution diluted within a range of predetermined concentration.

The first valve 33 is provided on the line L23 connected to a side where the fuel flows of the power generator 7. The second valve 34 is provided on the line L24 connected to another side where the fuel is discharged of the power generator 7. The concentration detector 42 is provided on the line L23.

The fuel supply unit 3 supplies the methanol or the mixed solution containing the methanol and the small amount of water from the fuel tank 2 to the power generator 7. The fuel circulation unit 5 circulates the methanol solution diluted within a predetermined range to the power generator 7. The fuel collection unit 35 collects the methanol solution discharged from the power generator 7. The fuel collection tank 36 temporary stores the methanol solution collected by the fuel collection unit 35. The first and second valves 33 and 34 control to flowing the fuel into the power generator 7 and discharging from the power generator 7. The power adjustment unit 9 removes electrical energy from the power generator 7. The temperature adjustment unit 13 adjusts the temperature of the power generator 7.

The concentration detector 42 detects the concentration of the methanol in the anode electrode of the power generator 7. With regard to a sensing method of such a methanol concentration of the anode electrode, it is also possible to detect the methanol concentration based on a relationship between the output of the power generator 7 and temperature of the temperature adjustment unit 13 instead of using the concentration detector 42.

The controller 10 controls the fuel supply unit 3, the fuel circulation unit 5, the temperature adjustment unit 13, the fuel collection unit 35, the power adjustment unit 9, and the first and second valves 33 and 34.

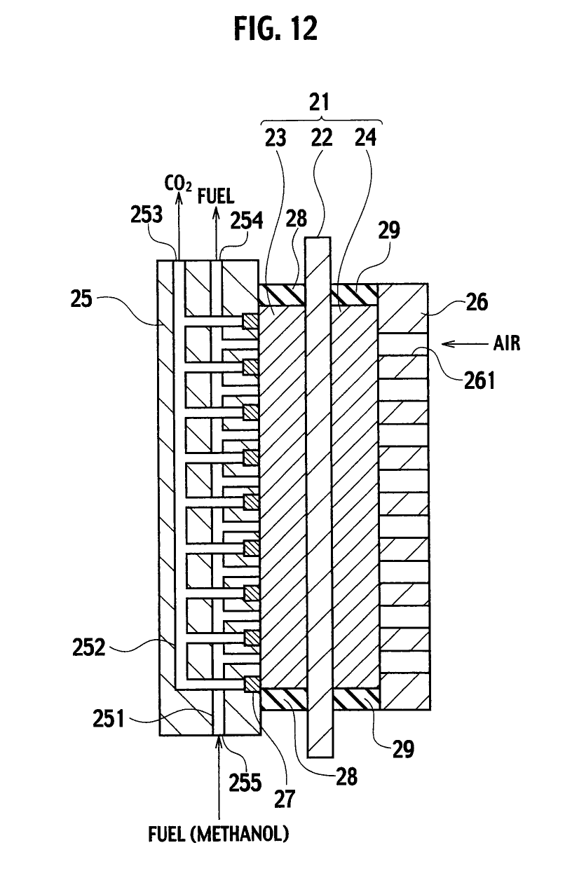

As shown in FIG. 12, the power generator 7 includes an anode passage plate 25, a MEA 21, a cathode collector 26, and gaskets 28 and 29.

The MEA 21 includes: an electrolyte membrane 22 formed of a proton-conductive polymer electrolyte membrane; anode and cathode electrodes 23 and 24 formed by coating catalysts on both surfaces of the electrolyte membrane 22. A carbon micro porous layer (MPL), an anode gas diffusion layer and cathode gas diffusion layer are provided on the outsides of the anode and cathode electrodes 23 and 24 by pressing. The configurations of the MEA 21 are substantially similar to the configurations of the MEAs 14c, 15c and 16c shown in FIG. 2, and accordingly, a duplicate description will be omitted.

Individually provided in the anode passage plate 25 is a fuel passage 251 that supplies the fuel through a fuel supply port 255 and discharges the unused fuel and the like through a fuel discharge port 254; and a gas passage 252 that discharges the gas generated by the reaction through a gas discharge port 253. In the gas passage 252, porous bodies (lyophobic porous bodies) 27 subjected to a water repellent treatment are placed on a side facing the MEA 21, whereby only the gas is allowed to permeate the gas passage 252, and the liquid is prevented from entering the same. A predetermined pressure is applied to the anode electrode 23 by the fuel circulation unit 5 so that the generated gas can be smoothly discharged from the gas passage 252. The current collection is performed by terminals provided partially on the anode passage plate 25. The cathode collector plate 26 is attached to an outer surface of the cathode electrode 24, in which air supply ports 261 receive air. The cathode collector plate 26 functions both to supply the air and to collect the current.

In the fuel cell system according to the second embodiment of the present invention, when the methanol and the water are consumed owing to the reaction and the permeation, fuel is supplied from the fuel tank 2 in the amount of the liquid thus consumed. In the lines L22, L23 and L24, only the liquid circulates all the time during the power generation. Therefore, when the crossover water is increased from the initial value after the fuel cell system is operated for a long period of time, a ratio of the permeating water with respect to the methanol is increased more than a ratio of the water supplied from the fuel tank 2 with respect to the methanol. Accordingly, a methanol solution with a higher concentration than the initial concentration will begin to circulate through a circulation loop of the lines L23 and L24, whereby the concentration of the methanol in the anode electrode 23 is increased. Then, the crossover methanol is increased, the output is decreased, and there is a possibility that the fuel cell system may become finally inoperable.

In the α recovery process according to the second embodiment of the present invention, the fuel supply unit 3, the fuel circulation unit 5, the temperature adjustment units 13 and the power adjustment unit 9 are discontinued from operation, and the first and second valves 33 and 34 are closed on both of the inlet and outlet sides of the power generator 7. Thereafter, the fuel collection unit 35 collects the methanol solution discharged from the anode electrode 23 of the power generator 7, and stores the collected methanol solution in the fuel collection tank 36. At this time, a flow from the anode electrode 23 of the power generator 7 to the fuel collection tank 36 side occurs. Accordingly, air is taken in from the gas discharge port 253 of the power generator 7, and the liquid is discharged from the anode electrode 23 side. As a result, the inside of the anode electrode 23 side of the power generator 7 can be dried. In order to determine whether or not to end such drying, a hygrometer is provided in the anode passage plate 25. Then, when a humidity value measured by the hygrometer reaches a predetermined value or less, it is determined to end the drying. In addition to the above, it is possible to set a time limit for the drying.

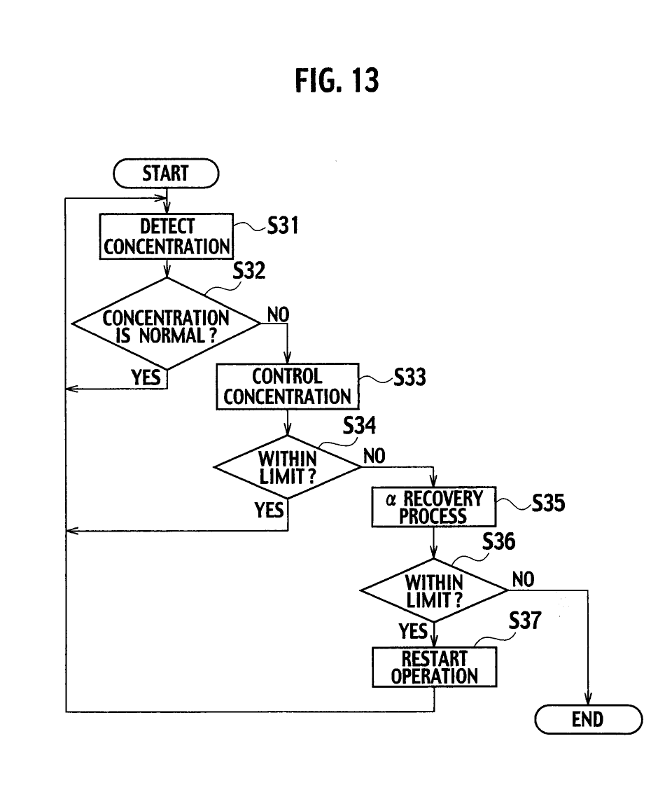

Next, an operation method of the fuel cell system including the α recovery process according to the second embodiment of the present invention will be described, referring to a flowchart of FIG. 13.

In Step S31, the operation is started. During the operation, the liquid amount detector 42 and the like detect the methanol concentration in the anode electrode 23 of the MEA 21. In Step S32, the controller 10 determines whether or not a value of the detected methanol concentration is within a predetermined range. The operation is normal when the concentration is within the predetermined range, and accordingly, the operation is continued while periodically detecting the concentration. When the concentration is not within such a normal range, the method proceeds to Step S33.

In Step S33, concentration control processing is performed. In the concentration control processing, the fuel supply unit 3 adjusts the supply of the fuel, the temperature adjustment unit 13 adjusts the temperature of the power generator 7, and the power adjustment unit 9 adjusts the load, and so on. The concentration control processing is repeatedly performed within a time limit or a number limit until the concentration returns to the predetermined range. When the concentration returns to the predetermined range, the method returns to Step S31. When the concentration does not return to a normal state within the time limit or the number limit, it is impossible to restore the concentration to the predetermined range, and accordingly, the method proceeds to Step S35.

In Step S35, the α recovery process is performed. The fuel supply unit 3, the fuel circulation unit 5, the temperature adjustment unit 13 and the power adjustment unit 9 are discontinued from operating, and the first and second valves 33 and 34 are closed. Thereafter, the fuel collection unit 35 collects the methanol solution discharged from the anode electrode 23 side of the power generator 7, whereby a flow from the anode electrode 23 side of the power generator 7 to the fuel collection tank 36 side occurs. Accordingly, air is taken in from the gas discharge port 253 of the power generator 7, and the liquid is discharged from the anode electrode 23 side. As a result, the inside of the anode electrode 23 of the power generator 7 can be dried.

In Step S36, the fuel in the fuel collection tank 36 is supplied to the power generator 7 after the end of the α recovery process. Then, the fuel collection unit 35 is stopped, and the first and second valves 33 and 34 are opened. Then, the fuel circulation unit 5 circulates the fuel through the power generator 7, the air supply unit 6 supplies air to the power generator 7, and the operation is resumed. In Step S36, the controller 10 determines whether or not the concentration has returned within the normal range by using a concentration meter or based on an output voltage therefrom. When the concentration has returned to the predetermined range, the method proceeds to Step S37, and the operation is continued. When the concentration has not returned to the predetermined range, there is some other reason for the concentration abnormality, and accordingly, the operation is discontinued.

In accordance with the fuel cell system according to the second embodiment of the present invention, the increase of the methanol concentration in the anode electrode 23 of the power generator 7, which is caused by the amount of crossover water that has increased over time, can be prevented. Furthermore, the increase of the crossover methanol and the decrease of the output can be prevented. Hence, the power generation efficiency can be maintained at a high level for a long period of time.

### Other Embodiments

Various modifications will become possible for those skilled in the art after receiving the teachings of the present disclosure without departing from the scope thereof. It is possible to operate by incorporating the first and second embodiments.

Furthermore, various alcohols, ethers or the like may be used as the fuel used in the fuel cell system according to the first and second embodiments of the present invention.

What is claimed is:

1. A fuel cell system comprising:
a fuel tank configured to store fuel;
a mixing tank configured to store a fuel solution diluted from the fuel;
a fuel supply unit configured to supply the fuel from the fuel tank to the mixing tank;
a power generator comprising a membrane electrode assembly having an electrolyte membrane, an anode electrode and a cathode electrode, the anode and cathode electrodes sandwich the electrolyte membrane, configured to generate power by reaction of the fuel solution supplied to the anode electrode with air supplied to the cathode electrode;
a fuel circulation unit configured to circulate the fuel solution from the mixing tank to the anode electrode;
an air supply unit configured to supply air to the cathode electrode;
an air supply mechanism configured to supply air to the anode electrode so as to discharge the fuel solution from the inside of the anode electrode to the mixing tank; and
a temperature adjustment unit configured to control a temperature of the power generator.

2. The system of claim 1, wherein the fuel solution is discharged from the inside of the anode electrode to the mixing tank through the fuel circulation unit by supplying air from the air supply mechanism to the anode electrode, and
the fuel circulation unit reversely circulates the fuel to flow the fuel from the air supply mechanism to the power generator.

3. The system of claim 1, further comprising a liquid amount detector configured to detect an amount of liquid in the mixing tank, and the fuel solution is discharged from the inside of the anode electrode to the mixing tank based on the amount of liquid.

4. The system of claim 1, further comprising a concentration detector configured to detect a concentration of liquid in the mixing tank, and air is taken into the anode electrode based on the concentration of the fuel.

5. The system of claim 1, wherein the power generator is one of a plurality of power generators, and the fuel solution is discharged from the inside of the anode electrode in each of the plurality of power generators to the mixing tank, individually.

6. The system of claim 5, wherein the fuel circulation unit is one of a plurality of fuel circulation units corresponding to each of the plurality of power generators.

7. The system of claim 1, wherein the fuel solution is discharged from the inside of the anode electrode to the mixing tank for a fixed time.

8. The system of claim 1, wherein the fuel solution is discharged from the inside of the anode electrode to the mixing tank at every time of ending the power generation.

9. The system of claim 1, wherein a notice that the system will enter a maintenance mode is issued to a user, before the fuel solution is discharged from the inside of the anode electrode to the mixing tank, and
the fuel solution is discharged from the inside of the anode electrode to the mixing tank after the notice is issued.

10. The system of claim 1, wherein the air supply mechanism is a gas-liquid separator provided in downstream side of the anode electrode, the gas-liquid separator separates a fluid generated by the reaction and discharged from the anode electrode into liquid and gas.

11. A fuel cell system comprising:
a fuel tank configured to store fuel;
a mixing tank configured to store a fuel solution diluted from the fuel;
a fuel supply unit configured to supply the fuel from the fuel tank to the mixing tank;
a power generator comprising a membrane electrode assembly having an electrolyte membrane, an anode electrode and a cathode electrode, the anode and cathode electrodes sandwich the electrolyte membrane, configured to generate power by reaction of the fuel solution supplied to the anode electrode with air supplied to the cathode electrode;
a fuel circulation unit configured to circulate the fuel solution from the mixing tank to the anode electrode;
an air supply unit configured to supply air to the anode electrode so as to discharge the fuel solution from the inside of the anode electrode to the mixing tank, and supply air to the cathode electrode; and
a temperature adjustment unit configured to control a temperature of the power generator.

12. The system of claim 11, further comprising:
a first valve provided between the air supply unit and the anode electrode; and
a second valve provided between the air supply unit and the cathode electrode.

13. A fuel cell system comprising:
a fuel tank configured to store fuel;
a power generator comprising a membrane electrode assembly having an electrolyte membrane, an anode electrode and a cathode electrode, the anode and cathode electrodes sandwich the electrolyte membrane, configured to generate power by reaction of the fuel solution supplied to the anode electrode with air supplied to the cathode electrode;
a fuel circulation unit configured to circulate the fuel from the fuel tank to the anode electrode;
a fuel supply unit configured to supply the fuel from the fuel tank to the fuel circulation unit;
a fuel collection unit configured to collect the fuel solution discharged from the anode electrode; and
a collection tank configured to collect the fuel solution collected by the fuel collection unit,
wherein the fuel collection unit collects the fuel solution discharged from the anode electrode, and air is taken in from the gas discharge port to the anode electrode, and
the power generator further comprises an anode passage plate configured to separate the fluid generated by the reaction into liquid and gas.

14. The system of claim 13, further comprising a concentration detector configured to detect a concentration of the fuel in the anode electrode, and air is taken into the anode electrode based on the concentration of the fuel.
